(19) United States
(12) Patent Application Publication
(10) Pub. No.: US 2019/0045585 A1
(43) Pub. Date: Feb. 7, 2019

(54) METHOD FOR OPERATING A HEATING APPARATUS, CONTROL DEVICE AND MOTOR VEHICLE

(71) Applicant: SMR Patents S.à.r.l., Luxembourg (LU)

(72) Inventor: Romeo Wieczorek, Stuttgart (DE)

(21) Appl. No.: 16/054,007

(22) Filed: Aug. 3, 2018

(30) Foreign Application Priority Data
Aug. 3, 2017 (DE) 10 2017 117 654.3

(51) Int. Cl. H05B 3/84; H05B 1/02

(52) U.S. Cl. CPC H05B 3/845; H05B 1/0236

(57) ABSTRACT

A method for operating a heating apparatus for a viewing surface, in particular an external viewing device of a motor vehicle, such as in the form of an external rearview mirror, in which a heating current of at least one heating element of the heating apparatus is measured and taken as basis for an input variable for a Mealy machine for controlling the heating capacity of the heating device. A control device which is designed to carry out such a method, and a motor vehicle having such a control device.

### CROSS-REFERENCE TO RELATED APPLICATIONS

This application claims the benefit of foreign priority to German Patent Application No. DE 10 2017 117 654.3, filed Aug. 3, 2017, which is herein incorporated by reference in its entirety for all purposes.

### BACKGROUND

### 1. Field of the Invention

The following description relates to a method for operating a heating apparatus for a viewing surface. For example, an external view apparatus of a motor vehicle, a control device for carrying out the method, and a motor vehicle having such a control device.

### 2. Description of Related Art

To prevent viewing surfaces, such as for example the mirror surfaces of external rearview mirrors, from steaming or icing up, such surfaces are often heated. A defined, constant heating current is normally used for this purpose. This means that such a heating device cannot adapt itself to changing ambient conditions, such that in many cases too much current is consumed. Especially in the case of electric vehicles, this may impair vehicle range.

A method is known from DE 10 2010 040 132 A1 which describes heating a surface in which an ambient value, such as for example a temperature, atmospheric humidity, the occurrence of rain or the occurrence of ice, is detected in order to control the heating energy for heating the surface as a function of the detected ambient value.

Such systems are often very complex and require additional sensors, which increase manufacturing costs. In addition, existing, uncontrolled systems cannot be readily upgraded in this way. A further problem of known systems lies in the often high level of control inertia. In particular in the case of rapid temperature changes, such as occur for example on transition from cold winter air conditions to a heated underground parking garage, this may lead to overdrive, which may damage the viewing surface due to what is then a much too high input of heat.

It is therefore at least one aspect to provide a method for operating a heating apparatus which overcomes the disadvantages of the prior art. This may be implemented with reduced effort even in the case of existing heating apparatuses. It is also an aspect to allow rapid control of the heating apparatus and increase power savings.

### SUMMARY

In an aspect, a method for operating a heating apparatus for a viewing surface, in particular an external viewing device of a motor vehicle, such as in the form of an external rearview mirror, in which a heating current of at least one heating element of the heating apparatus is measured and taken as basis for an input variable for a Mealy machine for controlling the heating capacity of the heating device. In this case it is preferable to determine a temperature of the at least one heating element from the measured heating current and to use the determined temperature as the input variable.

A Mealy machine is a finite state machine which may be used for simple control tasks. The term “machine” is here used in the sense of theoretical computer science and does not restrict the options for practical implementation of such a machine. Implementation may proceed both purely as a circuit and in the form of a program on a multipurpose calculating machine.

The output of a Mealy machine, in this case thus the control signals for the heating apparatus, is determined by its state and a respective input value. The input value used here is preferably the identified temperature of the at least one heating element. Said temperature thus determines the initial state of the Mealy machine and thus also the first control output.

Since the heating elements of conventional heating apparatuses generally consist of printed metal tracks, the resistance thereof has a temperature coefficient, i.e. it varies with the temperature of the heating element. It is therefore possible to draw conclusions from the measured heating current as to the temperature of the heating element. Since prior to being switched on the heating apparatus is in thermal equilibrium with the surroundings, the temperature determined from the heating current is thus substantially the ambient temperature.

A method is thus provided which, on the basis of the initially determined ambient temperature, allows stable control of the heating apparatus, which prevents unnecessary heating of the viewing surface and is insensitive to overdrive. It is moreover straightforwardly possible to adapt existing control devices for heating apparatuses to carry out such a method, since no additional sensors or electronic components are needed.

Provision may be made for the resistance and/or heating current in the at least one heating element to be measured repeatedly while the Mealy machine is running, and the heating current is adapted on the basis of this measurement. In other words, the repeatedly measured resistance and/or heating current in the heating element serves as an input variable for the further development over time of the Mealy machine and thus determines both the future state thereof and the control outputs thereof. In this way it may be ensured that the heating current remains in respectively predetermined set ranges and, for example, the viewing surface does not become overheated or is not unnecessarily heated.

Provision may further be made for the Mealy machine to include a table or to access a table which represents a relationship between the resistance of the at least one heating element and a resultant setpoint heating current. The table thus represents the control setting which the Mealy machine uses to control the heating current for the at least one heating element. Such a table may be computationally generated by modeling the heating apparatus or indeed also constructed on the basis of empirical values. The control process may thus for example also be recalibrated, for instance in the context of regular maintenance.

The Mealy machine may specify a value for the heating current according to the setpoint heating current determined from the table, and a heating current of the specified value may be fed into the at least one heating element. This constitutes the base state of the Mealy machine. Providing no input values are present which would make a change in the state of the Mealy machine necessary, control thus proceeds on the basis of the setpoint values specified in the table, which have preferably been optimized with regard to minimizing power consumption.

A pulse width-modulated heating current may be used, and a duty factor of the heating current may be adapted in the event of deviation of the measured heating current from the setpoint heating current. This makes possible particularly simple and rapid adaptation of the heating capacity of the heating apparatus. Duty factor is here understood to mean the ratio of the pulse width of the current to the periodic length thereof. By changing the duty factor, the energy output to the heating apparatus may thus be simply and precisely adapted.

The duty factor of the heating current may be reduced if the setpoint heating current is exceeded by the measured heating current. In other words, the pulse width of the heating current is thus reduced in this case, such that the output heating energy is reduced. This represents a further state of the Mealy machine, in which the latter remains until the heating current again corresponds to the setpoint heating current.

The duty factor of the heating current may be increased if the measured heating current falls below the setpoint heating current. If the above case is reversed, the pulse width of the heating current is here thus enlarged, such that the output heating energy is increased. This also represents a further state of the Mealy machine, in which the latter remains until the heating current again corresponds to the setpoint heating current.

A LIN (Local Interconnect Network) bus may be used for communication between a control device, on which the Mealy machine is implemented, and the heating apparatus. The method may thus be implemented on existing bus systems which are present in any event in the motor vehicle. Complex and costly upgrading of the motor vehicle is therefore unnecessary.

In another aspect, a control device which is designed to carry out the above-described method, and to a motor vehicle with such a control device. Here too, the stated advantages take effect.

While it is conventional in the prior art in particular for external motor vehicle mirrors to have a heater, the temperature thereof is not however fed back to the motor vehicle to allow the heater current to be controlled, in particular to save power. It is even possible according to the following description to feedback information about the temperature of a mirror to the motor vehicle without additional hardware and solely on the bases of software changes, in order to drive the heater in a resource-optimizing manner. This allows an automotive manufacturer inter alia also to equip both their current series and their new series with a power saving function solely by way of a software update. This is particularly attractive also for electric vehicles so as to increase the range thereof.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the invention is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the invention.

FIG. 1 shows a state diagram of a Mealy machine used in the context of an exemplary embodiment of the method according to the invention.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The state diagram shown in FIG. 1 illustrates the five possible states S0 . . . S4 of a Mealy machine suitable for use in an exemplary embodiment of the method. The states are shown here as circles (nodes of the state diagram). Arrows (edges of the state diagram) characterize possible transitions between states S0 . . . S4.

In a Mealy machine, transition between two states proceeds as a function of an input. At the same time, an output is generated which is dependent both on the respective state S0 . . . S4 and on the input.

For use for controlling a heating apparatus, a measured value for the current through at least one heating element of the heating apparatus serves as an input value for the Mealy machine shown. The current actually flowing through the heating element is namely proportional to the resistance of the heating element, which is turn dependent on the temperature of the heating element due to its temperature coefficient. The Mealy machine thus indirectly receives as input an item of information about the temperature of the at least one heating element.

The output value represents the duty factor of a pulse width-modulated heating current which is fed into the at least one heating element. The duty factor of a pulse width-modulated signal corresponds to the ratio between pulse width and period of the signal. More energy is thus fed into the at least one heating element per unit time in the case of a higher duty factor than in the case of a lower duty factor.

Overall, therefore, control of the heating capacity may thus be realized as a function of the temperature of the at least one heating element and it may thus be ensured that predetermined nominal temperatures may be complied with.

A method according to the invention may proceed as follows:

Upon switching on of the heating apparatus, first of all a test pulse is output to the at least one heating element and the resultant current flow through the at least one heating element is recorded. Since, before it is switched on, the heating element is in thermal equilibrium with the surrounding environment, this current flow is thus dependent on the ambient temperature.

The ambient temperature thus serves as an initial input for the Mealy machine. This is in state S0 when the heating apparatus is switched on and then takes the heating current respectively desired on the basis of the temperature from a table reproducing an accurately calculated interrelationship between the temperature or the internal resistance of the at least one heating element and an associated setpoint heating current. The heating current selected in this way is then applied to the at least one heating element.

In other words, on the basis of the initial input, the respectively relevant heating program is thus determined for the heating apparatus, compliance with which is then monitored and ensured by the Mealy machine.

During further operation of the heating apparatus, the current flow is then measured periodically by the at least one heating element. Providing this continues to correspond to the setpoint input, the Mealy machine remains in state S0 and controls the heating apparatus according to the table setpoint value.

If the measured current flow is too high, the Mealy machine transitions into state S1 and then state S2. As an output, the Mealy machine then generates a reduced duty factor for the heating current, such that less energy is supplied to the heating apparatus and it cools down accordingly. The machine remains in these states until a new input, i.e. a new measured current flow through the at least one heating element, is present which corresponds to the setpoint value in the table. As soon as this is the case, the Mealy machine returns to the base state S0.

Similarly, the Mealy machine transitions to state S3 and then state S4 if the measured current flow is too low. As an output, the Mealy machine then generates an increased duty factor for the heating current, such that more energy is supplied to the heating apparatus and it heats up accordingly. The machine then remains in these states again until a new input, i.e. a new measured current flow through the at least one heating element, is present which corresponds to the setpoint value in the table. As soon as this is the case, the Mealy machine returns to the base state S0.

Overall, therefore, the heating capacity and thus the temperature of the heating apparatus is thus kept stably at the specified setpoint according to the table and the ambient temperature determined by the initial test pulse. Since every state change of a Mealy machine is directly concomitant with an output, control is additionally very rapid and thus avoids overdrive, as may occur with more sluggish open- or closed-loop control systems. The Mealy machine shown may additionally be simply implemented in existing control devices, such that all that may be needed to equip an older system is a software update.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

### REFERENCE LIST

S0 . . . S4 States of the Mealy machine

1. A method for operating a heating apparatus for an external viewing device of a motor vehicle such as an external rearview mirror, the method comprising:
measuring a heating current of at least one heating element of the heating apparatus; and
using the measured heating current as a basis for an input variable for a Mealy machine for controlling a heating capacity of the heating apparatus.

2. The method according to claim 1, further comprising:
determining a temperature of the at least one heating element from the measured heating current; and
using the determined temperature as the input variable.

3. The method according to claim 1, further comprising:
measuring at least one of a resistance and the heating current in the at least one heating element repeatedly while the Mealy machine is running; and
adjusting the heating current based on this repeated measurement.

4. The method according to claim 3, further comprising accessing a table, using the Mealy machine, which represents a relationship between the resistance of the at least one heating element and a resultant setpoint heating current.

5. The method according to claim 4, further comprising
specifying a value for the heating current, the Mealy machine, according to the setpoint heating current determined from the table; and
feeding a heating current of the specified value into the at least one heating element.

6. The method according to claim 4, wherein a pulse width-modulated heating current is used, and a duty factor of the heating current is adapted in the event of deviation of the measured heating current from the setpoint heating current.

7. The method according to claim 6, further comprising
reducing the duty factor of the heating current in response to the setpoint heating current being exceeded by the measured heating current, or
increasing the duty factor of the heating current in response to the measured heating current falling below the setpoint heating current.

8. The method according to claim 1, further comprising using a LIN bus for communication between a control device, on which the Mealy machine is implemented, and the heating apparatus.

9. A control device, which is set up to carry out a method according to claim 1.

10. A motor vehicle having a control device according to claim 9.
